(19) United States
(12) Patent Application Publication
(10) Pub. No.: US 2019/0020131 A1
(43) Pub. Date: Jan. 17, 2019

(54) ORNAMENTAL BOARD CONNECTION SYSTEM

(71) Applicant: Fanae Aaron, Los Angeles, CA (US)

(72) Inventor: Fanae Aaron, Los Angeles, CA (US)

(21) Appl. No.: 15/952,788

(22) Filed: Apr. 13, 2018

Related U.S. Application Data
(60) Provisional application No. 62/531,463, filed on Jul. 12, 2017.

(51) Int. Cl. H01R 12/70; H01R 4/48; H01R 13/426

(52) U.S. Cl. CPC H01R 12/7005; H01R 13/426; H01R 4/48

(57) ABSTRACT

The main board abutment sidewall is parallel to the main board outside mounting groove. The first attachment board outside mounting groove is parallel to the main board outside mounting groove. A first attachment board abutment sidewall formed on the first attachment board. The first attachment board abutment sidewall abuts the main board abutment sidewall when the first attachment board is mounted to the main board. The pair of prongs includes an inside prong and an outside prong. The inside prong is installed to the main board outside mounting groove, and the outside prong is installed to the first attachment board outside mounting groove. The inside grip and the outside grip are both elastomeric.

This application is a non-provisional of and claims priority from U.S. provisional patent application 62/531,463, by inventor Fanae Aaron filed Jul. 18, 2017, entitled Ornamental Arrangement Of At Least Two Geometric Shapes, the disclosure of which is incorporated herein by reference.

### DISCUSSION OF RELATED ART

The embodiments herein relate generally to hanging boards for ornamental purposes.

Prior to embodiments of the disclosed invention hanging separate boards for decorative purposes or otherwise on a wail created damage from many holes. Changing the arrangement created even more damage to walls. Embodiments of the disclosed invention solve this problem. A variety of different systems have been used for hanging ornamental boards of artistic work such as sculptures, paintings, and photographs.

### SUMMARY OF THE INVENTION

An ornamental arrangement has at least two geometric shapes. The ornamental arrangement includes a first geometric shape that has a first backing with a first slot. A second geometric shape has a second backing with a second slot. A clip connects the first slot with the second slot.

An ornamental board connection system includes: a main board; a main board outside mounting groove formed on the main board; a main board abutment sidewall formed on the main board, a first attachment board; a first attachment board outside mounting groove formed on the first attachment board; a clip having a clip body and a pair of prongs extending from the clip body; and an inside grip attached to the inside prong, and an outside grip attached to the outside prong.

The main board abutment sidewall is parallel to the main board outside mounting groove. The first attachment board outside mourning groove is parallel to the main board outside mounting groove. A first attachment board abutment sidewall formed on the first attachment board. The first attachment board abutment sidewall abuts the main board abutment sidewall when the first attachment board is mounted to the main board. The pair of prongs includes an inside prong and an outside prong. The inside prong is installed to the main board outside mounting groove, and the outside prong is installed to the first attachment board outside mounting groove. The inside grip and the outside grip are both elastomeric.

The ornamental board connection system also optionally includes a main board inside mounting groove formed on the main board. The main board inside mounting groove is configured to receive a second clip. The second clip is mounted to both the main board inside mounting groove and the main board outside mounting groove. Connector clip openings are formed on the second clip.

A second attachment board can also be mounted to the connection system. The second attachment board has a second attachment board abutment sidewall. The second attachment board abutment sidewall abuts the main board abutment sidewall when the second attachment board is mounted to the main board. The second attachment board also has a second attachment board outside mounting groove that is formed parallel to the main board outside mounting groove.

The inside prong and the outside prong have a pair of grips such that the inside prong receives an inside grip and the outside prong receives an outside grip. The inside prong has an inside prong tip, and the outside prong has an outside prong tip. The pair of grips have a first grip area, a second grip area at a third grip area. The first grip area and the third grip area have a difference of compressive pressure when the first attachment board is mounted to the main board. The first grip area has widthwise ridges, and the third grip area has widthwise ridges. The second grip area has lengthwise ridges. The second grip area is formed between the first grip area and the third grip area.

### BRIEF DESCRIPTION OF THE DRAWINGS

The detailed description of some embodiments of the invention is made below with reference to the accompanying figures.

FIG. 1 is a diagram of the present invention having three connected boards, showing the back side that is typically attached to the wall and not visible to the observer.

FIG. 2 is a diagram of a single board with a cross-section view of a slot for a clip.

FIG. 3 is a cross-section diagram of a clip installed to connect a pair of boards.

FIG. 4 is a side view of a grip.

FIG. 5 is a top view of a grip.

FIG. 6 is a perspective view of a grip.

The following call outs can be a useful guide in referencing the elements of the drawings.
21 main board
22 outside mounting groove
23 inside mounting groove
24 first outside mounting groove corner
25 inside mounting groove end
26 outside mounting groove end
27 second outside mounting groove corner
28 third outside mounting groove corner
29 laminate layer
31 first attachment board
32 second attachment board
33 first attachment board margin
34 second attachment board margin
35 first attachment board abutment sidewall
36 second attachment board abutment sidewall
37 main board abutment sidewall
40 connector clip
41 clip body
42 connector clip openings
43 inside prong
44 outside prong
45 inside prong tip
46 outside prong tip
47 inside grip
48 outside grip
50 grip
51 inside grip connection
52 outside grip connection
53 first set of ridges
54 second set of ridges
55 third set of ridges
56 widthwise ridge
57 lengthwise ridge
58 gripping surface
61 main board margin
62 main board middle field
63 first abutment area
64 second abutment area
65 first grip area
66 second grip area
67 third grip area

### DETAILED DESCRIPTION OF THE PREFERRED EMBODIMENT

Bye way of example, one embodiment of the present system comprises a first geometric shape that has a first backing with a first slot. A second geometric shape has a second backing with a second slot. A clip connects the first slot with the second slot.

The clip can be u-shaped with the parallel sides each side having a liner that makes a snug fit and creates friction in the slot. The channel can accommodate the first slot and the second slot. Each channel creates a non-flexible structure for the liner. The channel with the liner can connect shaped boards together creating a snug fit and friction to prevent sliding, slipping, shifting or falling out of place once inserted into the slots on the boards. The channel with the liner can also be affixed to walls to keep shapes level and steady when hung off-center. In some embodiments, the clip can be used to connect a shelf onto the first geometric shape.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

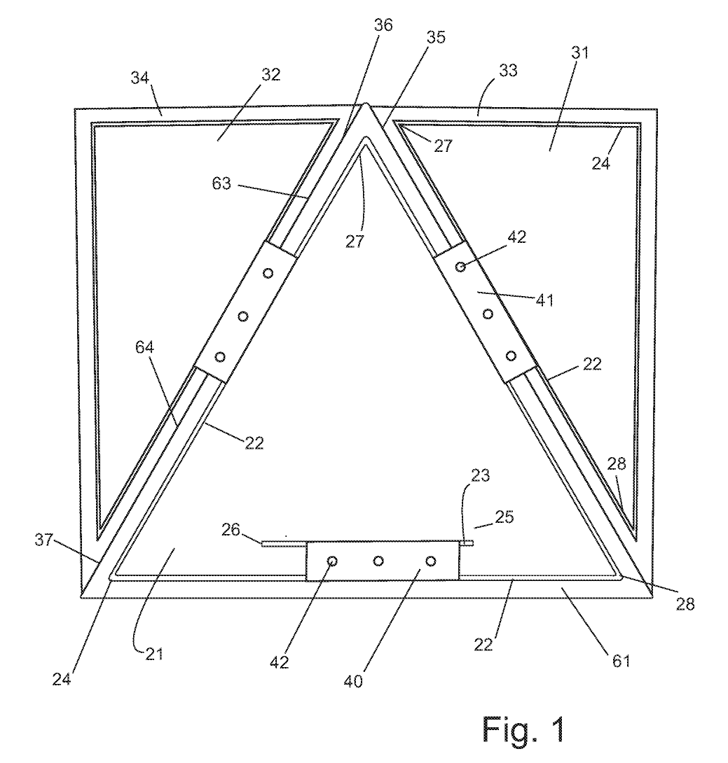

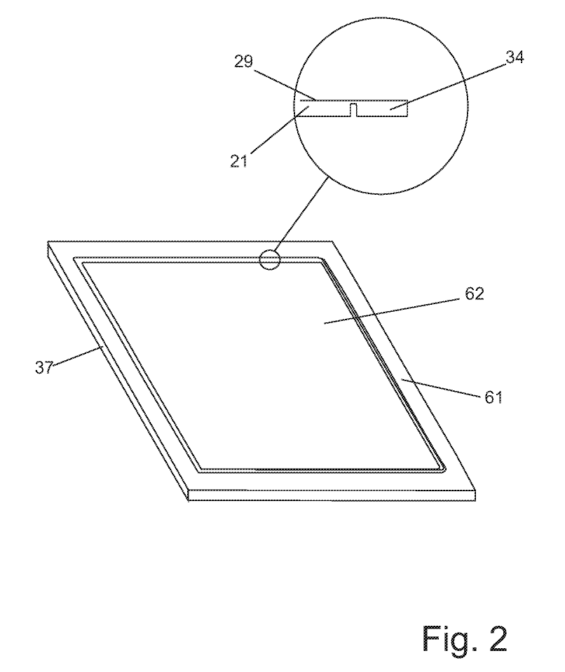

As seen in FIG. 1, a main board 21 has an outside mounting groove 22 and an inside mounting groove 23. The outside mounting groove 22 is formed as a slot and can be routed or cut or formed on a board. The board is preferably high density fiberboard, or can be made as an injection molded piece. The board can also be made of a softer material for sound absorption. The board can be wrapped with a laminate layer 29 such as cloth or a printed graphic layer such as a printed graphic aluminum layer. A variety of different service treatments can also be applied to the board.

The main board 21 has the inside mounting groove 21 formed within the boundary of the outside mounting groove 22. The outside mounting groove 22 circumscribes the external periphery of the main board 21 at a set distance from a main board abutment sidewall 37. The connector clip 40 is configured to mount inside the outside mounting groove. The connector clip 40 can be mounted to the inside mounting groove and the outside mounting groove simultaneously for attachment to a vertical surface such as a wall. The outside mounting groove 22 therefore takes on the geometric shape of the board in which it is formed. For example, in the figures, the outside mounting groove 22 can be triangular in shape and have a first outside mounting groove corner 24, a second outside mounting groove corner 27, and a third outside mounting groove corner 28. The word corner here is used generally to describe vertices of polygons. The outside mounting groove 22 forms a margin area between itself and the sidewall or edge of the board.

The connector 40 has connector clip openings 42 that can receive screws or other types of connectors for connection to a wall. For example in a wood frame wall, the connector clip opening 42 can receive a screw that secures the connector 42 a wall stud. The first attachment board 31 abuts the main board. The first attachment board 31 has a first attachment board margin 33, and the second attachment board 32 has a second attachment board margin 34. The main board abuts the first attachment board abutment sidewall 35 of the first attachment board 31 at a main board abutment sidewall 37. Similarly, the main board abuts the second attachment board abutment sidewall 36 of the second attachment board 32 at a main board abutment sidewall 37.

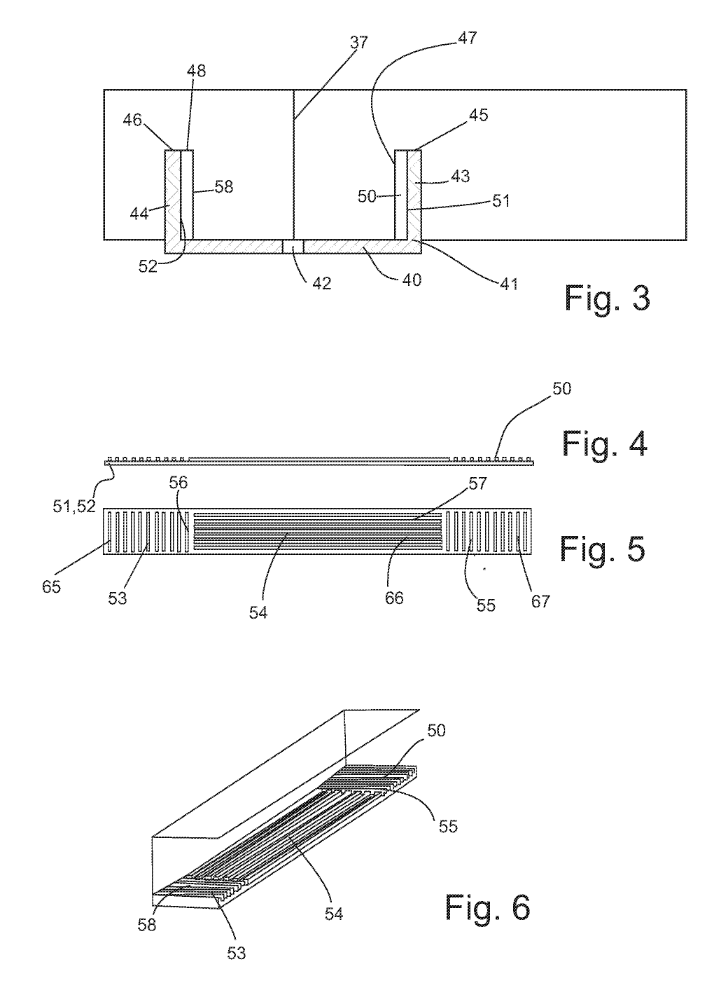

As seen in FIG. 3, the boards are held together by the connector clips 40. The connector clips 40 are rigid and are preferably made of aluminum extrusion material. The interface between the abutment sidewall's have a resilient bias due to a gripping surface 58 formed on a grip 50 which is installed to the connector clips 40. The connector clips have a clip body 41 from which a pair of prongs extend. An inside prong 43 and an outside prong 44 extend from the clip body 41. The inside prong 43 terminates at an inside prong tip 45 and the outside prong 44 terminates at an outside prong tip 46.

The grip 50 is attached to the prong on the inside surfaces of the prongs. An inside prong retains the main board and the outside prong retains the attachment board which is attached to the main board. Therefore, the pair of prongs retains the boards to each other. While the prong itself is preferably rigid, the grip 50 is preferably elastomeric such as a silicone material. The grip 50 includes the inside grip 47 and the outside grip 48 which are preferably adhered to the inside surfaces of the prongs at an inside grip connection 51 and an outside grip connection 52. The grips extend from the prong tips 45, 46 to the clip body 41.

As seen in FIGS. 4-6, each of the grips on each of the prongs has a first set of ridges 53, a second set of ridges 54, and a third set of ridges 55. The second set of ridges 54 is formed between the first set of ridges 3 and the second set of ridges 55. The second set of ridges 54 has lengthwise ridges 57. The first set of ridges 53 and the second set of ridges 55 have widthwise ridges 56. The widthwise ridges are perpendicular to the lengthwise ridges. Since the grip orientation rotates 90°, it allows the grip to retain in both a horizontal and vertical orientation so as to retain the boards to each other. Generally, the first grip area 65 has a first set of ridges 53, and a second grip area 66 has a second set of ridges 54, and a third grip area 67 has a third set of ridges 55. Alternatively, the first grip area 65 can have lengthwise ridges and the second grip area can have widthwise ridges.

The prong ridges are shaped as protrusions which extend beyond a fiat plane of the liner. The elastomeric protrusions are configured so that they bias against the board in which they are installed. The main board abutment sidewall 37 abuts against the attachment board sidewalls. The attachment boards slump relative to the main board so that a first abutment area 63 has a different abutment compressive pressure than a second abutment area 64. Although there is preferably no noticeable gap in the first abutment area 63 and the second abutment area 64, the difference of the compressive pressure biases the elastomeric protrusions differently such that the first set of ridges and the third set of ridges have a different compressive pressure applied to them. The difference in compressive pressure is due to a torque that is applied to the clip and thus the ridges when the boards are hung. This allows the user to remove the board easily by alleviating the torque when removing the boards and assembling the boards, but when the boards are installed, they bind to each other and are secure.

The boards can have other ornamental features mounted to them such as domes, flowers and the like. Groove and slot are generally synonymous. The prongs can extend at a normal 90° angle or at an angle that is not 90°, but 90° angle is the best mode. The torque applied to the clip can be minimal and is due to the clip being installed asymmetrically and unaligned to the center of gravity.

1. An ornamental board connection system comprising:
a. a main board;
b. a main board outside mounting groove formed on the main board;
c. a main board abutment sidewall formed on the main board, wherein the main board abutment sidewall is parallel to the main board outside mounting groove;
d. a first attachment board;
e. a first attachment board outside mounting groove formed on the first attachment board, wherein the first attachment board outside mounting groove is parallel to the main board outside mounting groove;
f. a first attachment board abutment sidewall formed on the first attachment board, wherein the first attachment board abutment sidewall abuts the main board abutment sidewall, wherein the first attachment board is mounted to the main board;
g. a clip having a clip body and a pair of prongs extending from the clip body, wherein the pair of prongs includes an inside prong and an outside prong, wherein the inside prong installed to the main board outside mounting groove, and when the outside prong is installed to the first attachment board outside mounting groove; and
h. an inside grip attached to the inside prong, and an outside grip attached to the outside prong, wherein the inside grip and the outside grip are both elastomeric.

2. The ornamental board connection system of claim 1, further comprising: a main board inside mounting groove formed on the main board, wherein the main board inside mounting groove is configured to receive a second clip, wherein the second clip is mounted to both the main board inside mounting groove and the main board outside mounting groove.

3. The ornamental board connection system of claim 1, further comprising: connector clip openings formed on the second clip.

4. The ornamental board connection system of claim 1, further comprising: a second attachment board, wherein the second attachment board has a second attachment board abutment sidewall, wherein the second attachment board abutment sidewall abuts the main board abutment sidewall when the second attachment board is mounted to the main board, wherein the second attachment board also has a second attachment board outside mounting groove that is formed parallel to the main board outside mounting groove.

5. The ornamental board connection system of claim 1, wherein the inside prong and the outside prong have a pair of grips such that the inside prong receives an inside grip and the outside prong receives an outside grip, wherein the inside prong has an inside prong tip, wherein the outside prong has an outside prong tip.

6. The ornamental board connection system of claim 5, further comprising: a main board inside mounting groove formed on the main board, wherein the main board inside mounting groove is configured to receive a second clip, wherein the second clip is mounted to both the main board inside mounting groove and the main board outside mounting groove.

7. The ornamental board connection system of claim 5, further comprising: connector clip openings formed on the second clip.

8. The ornamental board connection system of claim 5, further comprising: a second attachment board, wherein the second attachment board has a second attachment board abutment sidewall, wherein the second attachment board abutment sidewall abuts the main board abutment sidewall when the second attachment board is mounted to the main board, wherein the second attachment board also has a second attachment board outside mounting groove that is formed parallel to the main board outside mounting groove.

9. The ornamental board connection system of claim 5, wherein the pair of grips have a first grip area, a second grip area at a third grip area, wherein the first grip area and the third grip area have a difference of compressive pressure when the first attachment board is mounted to the main board.

10. The ornamental board connection system of claim 9, further comprising: a main board inside mounting groove formed on the main board, wherein the main board inside mounting groove is configured to receive a second clip, wherein the second clip is mounted to both the main board inside mounting groove and the main board outside mounting groove.

11. The ornamental board connection system of claim 9, further comprising: connector clip openings formed on the second clip.

12. The ornamental board connection system of claim 9, further comprising: a second attachment board, wherein the second attachment board has a second attachment board abutment sidewall, wherein the second attachment board abutment sidewall abuts the main board abutment sidewall when the second attachment board is mounted to the main board, wherein the second attachment board also has a second attachment board outside mounting groove that is formed parallel to the main board outside mounting groove.

13. The ornamental board connection system of claim 9, wherein the first grip area has widthwise ridges, wherein the third grip area has widthwise ridges, and wherein the second grip area has lengthwise ridges, wherein the second grip area is formed between the first grip area and the third grip area.

14. The ornamental board connection system of claim 13, further comprising: a main board inside mounting groove formed on the main board, wherein the main board inside mounting groove is configured to receive a second clip, wherein the second clip is mounted to both the main board inside mounting groove and the main board outside mounting groove.

15. The ornamental board connection system of claim 13, further comprising: connector clip openings formed on the second clip.

16. The ornamental board connection system of claim 13, further comprising: a second attachment board, wherein the second attachment board has a second attachment board abutment sidewall, wherein the second attachment board abutment sidewall abuts the main board abutment sidewall when the second attachment board is mounted to the main board, wherein the second attachment board also has a second attachment board outside mounting groove that is formed parallel to the main board outside mounting groove.
